(19) United States
(12) Patent Application Publication
(10) Pub. No.: US 2018/0053198 A1
(43) Pub. Date: Feb. 22, 2018

(54) METHOD AND SYSTEM FOR MARKETING RESEARCH

(71) Applicants: Inna SCHNEIDERMAN, Givat Shmuel (IL); Elhanan MEIROVITHZ, Hadera (IL)

(72) Inventors: Inna SCHNEIDERMAN, Givat Shmuel (IL); Elhanan MEIROVITHZ, Hadera (IL)

(21) Appl. No.: 15/555,530

(22) PCT Filed: Mar. 3, 2016
(86) PCT No.: PCT/IB2016/051206

§ 371 Date: Sep. 4, 2017

Related U.S. Application Data
(60) Provisional application No. 62/128,536, filed on Mar. 5, 2015.

(51) Int. Cl. G06Q 30/02

(52) U.S. Cl. CPC G06Q 30/0203; G06Q 30/0204

(57) ABSTRACT

A system for generating marketing research, comprising: a database configured to store a plurality of traits, at least one category and a plurality of human visual stimuli each comprising a person image; a display configured to present selected ones of the stimuli and at least one test question associated with a target product or service to a plurality of first respondents; GUI means configured to enable the first respondents to answer the at least one test question; and a processor configured to analyze the first respondents' answers to the at least one test question and use the database to indirectly reveal consumers' thoughts about the target product or service and create at least one report of a target population for the target product or service that can be used as a marketing tool.

### FIELD OF INVENTION

The present invention relates generally to marketing research, and specifically to analysis of consumers.

### BACKGROUND TO THE INVENTION

Understanding consumers' purchasing decisions, their thoughts and motives is vital for marketing professionals who need to develop effective and focused marketing campaigns to promote their brands and products. However, an extensive marketing experience as well as psychological research suggest that it is almost impossible to explore consumers' mind by merely asking people what they think and want (Morwitz et al., 1997; Puccinelli et al., 2001; Zaltman, 2003). Despite the popular belief that consumers can plausibly explain their thoughts and behavior, a contemporary scientific research has found that approximately 90-95% of thinking process takes place in our subconscious mind (Kahneman, 2013; Zaltman, 2003). In particular, purchasing decisions are based mostly on these subconscious thoughts, whereas conscious thoughts are used primarily to rationalize decisions and behaviors post factum (Bargh 2002; Chartland et al., 2005; Dijksterhuis et al., 2005; Kahneman, 2013; Winkielman & Berridge 2004).

Traditional consumer research largely ignores the contents of the subconscious mind. It comprises methods like surveys, focus groups and interviews, as well as more recent social media analysis tools, are based on consumers' explicit self reports about their thoughts and feelings towards products and brands. These methods fail to reveal consumers' cognitions that drive their purchasing decisions for several reasons. Firstly, as it mentioned above, purchasing decisions are based mostly on subconscious mind (Kahneman, 2013; Zaltman, 2003). Subconscious mind operates automatically and quickly with little or no sense of awareness or voluntary control. Thus, consumers may be unaware of their thoughts and actual motives, and thus unable to articulate them. Secondly, self-report methods are based on consumers' verbal responses, whereas human thoughts are image-based, not word-based (Weiser, 1988; Zaltman, 1997). Verbal language was developed relatively recently in human evolution, and nonverbal communication typically dominates a person's subconscious mind. Thus, translation of image-based thoughts into a human language in order to report it may cause biases (Zaltman, 1997). Thirdly, and lastly, respondents may be unwilling to admit their attitudes and beliefs, especially in social sensitive issues (Boddy 2007). Thus, there are substantial limitations of explicit verbal measures in capturing consumers' non-communicable, subconscious thoughts and attitudes toward products and brands.

Implicit projective techniques have been proposed to access actual consumers' cognitions that drive their purchasing behavior. Based on psychoanalytical theory (Lilienfeld et al., 2000), these techniques rely on the assumption that respondents will project their own subconscious thoughts and emotions onto some other person or object and in doing so reveal their own attitudes (Boddy, 2005). Psychological and marketing studies found that these projective techniques can be used to uncover a consumer's subconscious motives and attitudes towards a product by accessing his or her thoughts in an indirect and nonthreatening manner (Boddy, C. R. 2004; Haire, 1950).

Although projective techniques have been shown to be a powerful tool for capturing a respondent's deepest thoughts and feelings, these tools suffer from serious methodological limitations. The substantial majority of projective indices are subjectively scored, and thus the interpretation of the results can be as much a projection of the researcher as of the respondent (Boddy 2005). As a result, the scientific status of currently used projective techniques is highly controversial (Lilienfeld et al., 2000).

There is a long felt need for a system and method that explores and measures respondent's subconscious thoughts in order to enable marketing research.

### SUMMARY OF THE INVENTION

According to an aspect of the present invention, there is provided a system for generating marketing research, comprising: a database configured to store a plurality of traits, at least one category and a plurality of human visual stimuli each comprising a person image; a display configured to present selected ones of the stimuli and at least one test question associated with a target product or service to a plurality of first respondents; GUI means configured to enable the first respondents to answer the at least one test question; and a processor configured to analyze the first respondents' answers to the at least one test question and use the database to indirectly reveal consumers' thoughts about the target product or service and create at least one report of a target population for the target product or service that can be used as a marketing tool.

The system may further comprise a plurality of Persona Tests and the database may further comprise first weights between the selected ones of the stimuli and at least part of the plurality of traits, second weights between the selected ones of the stimuli and at least one of the at least one category and third weights between the at least part of the plurality of traits and the at least one of the at least one category.

The plurality of Persona Tests may comprise a plurality of Persona-trait Tests and a plurality of Persona-category Tests.

Each one of the plurality of Persona-trait Tests may comprise a stimulus comprising a person image, a trait and a trait question associating the trait and the person image; and wherein each one of the plurality of Persona-category Tests may comprise a stimulus comprising a person image, a category and a category question associating the category with the person image.

The system may further comprise an analysis module configured to analyze answers of a plurality of second respondents to the plurality of trait questions and to the plurality of category questions, thereby determining the first, second and third weights corresponding to the person image.

The selected stimuli may be selected from the plurality of human visual stimuli according to a demographic profile of each second respondent who answered a question regarding the stimuli.

The demographic profile may comprise at least one of age, gender, residence, education level and socio-economic profile.

The selected stimuli may be selected from the plurality of human visual stimuli according to a reaction time of each second respondent who answered a question regarding the stimuli.

The value of each of the first weights may be equal to the proportion of second respondents who gave a positive answer to one of the traits questions related to the selected stimuli; and wherein the value of each of the second weights may be equal to the proportion of second respondents who gave a positive answer to one of the category questions related to the selected stimuli.

The value of each of the third weights may be equal to the division of a second weight and a respective first weight corresponding to the same person image.

The analyzing the first respondents' answers may comprise calculating a trait power value by the multiplication of each of the first weights and the proportion of first respondents who gave a positive answer to one of the at least one test questions regarding a respective person image.

The analyzing the first respondents' answers may comprise calculating a category power value by the multiplication of each of the first weights, each of the third weights and the proportion of first respondents who gave a positive answer to one of the at least one test questions regarding a respective person image.

The selected stimuli may be selected according to a marketer's definitions.

According to another aspect of the present invention, there is provided a method of generating marketing research, comprising: defining a research comprising a target product or service, target population, at least one marketer category and at least one test question associated with the target product or service; selecting a plurality of human visual stimuli each comprising a person image from a database comprising a plurality of human visual stimuli; presenting the selected plurality of human visual stimuli and the target product or service along with the at least one test question to a plurality of first respondents; analyzing the first respondents' answers to the at least one test question to indirectly reveal the first respondents' thoughts about the target product or service; and creating at least one report based on the analysis thereby providing information about the target product or service that can be used as a marketing tool.

The database may further comprise a plurality of traits, at least one category, first weights between each person image and each of the plurality of traits, second weights between each person image and each of the at least one category and third weights between each of the plurality of traits and each of the at least one category.

The method may further comprise a plurality of Persona Tests.

The plurality of Persona Tests may comprise a plurality of Persona-trait Tests and a plurality of Persona-category Tests.

Each one of the plurality of Persona-trait Tests may comprise a stimulus comprising a person image, a trait and a trait question associating the trait and the person image; and wherein each one of the plurality of Persona-category Tests may comprise a stimulus comprising a person image, a category and a category question associating the category with the person image.

The method may further comprise analyzing answers of a plurality of second respondents to the plurality of traits questions and to the plurality of category questions, thereby determining the first, second and third weights corresponding to the person image.

The selected stimuli may be selected from the plurality of human visual stimuli according to a demographic profile of each second respondent who answered a question regarding the stimuli.

The demographic profile may comprise at least one of age, gender, residence, education level and socio-economic profile.

The selected stimuli may be selected from the plurality of human visual stimuli according to a reaction time of each second respondent who answered a question regarding the stimuli.

The value of each of the first weights may be equal to the proportion of second respondents who gave a positive answer to one of the trait questions related to the selected stimuli; and wherein the value of each of the second weights may be equal to the proportion of second respondents who gave a positive answer to one of the category questions related to the selected stimuli.

The value of each of the third weights may be equal to the division of a second weight and a respective first weight corresponding to the same person image.

The analyzing the first respondents' answers may comprise calculating a trait power value by the multiplication of each of the first weights and the proportion of first respondents who gave a positive answer to one of the at least one test questions regarding a respective person image.

The analyzing the first respondents' answers may comprise calculating a category power value by the multiplication of each of the first weights, each of the third weights and the proportion of first respondents who gave a positive answer to one of the at least one test questions regarding a respective person image.

The selected stimuli may be selected according to the at least one marketer category.

The selecting may comprises, when there are not enough stimuli to select, performing a plurality of second Persona Tests.

The plurality of second Persona Tests may comprise a plurality of Persona-trait Tests and a plurality of Persona-category Tests.

Each one of the plurality of Persona-trait Tests may comprise a stimulus comprising a person image, a trait and a trait question associating the trait and the person image; and wherein each one of the plurality of Persona-category Tests may comprise a stimulus comprising a person image, a category and a category question associating the category with the person image.

The method may further comprise analyzing answers of a plurality of third respondents to the plurality of traits questions and to the plurality of category questions, thereby determining a first, second and third weights corresponding to the person image.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic view of the system according to embodiments of the present invention;

FIG. 2 is a Structure of the Standardized Human Visual Stimuli Database according to embodiments of the present invention;

FIG. 3 is a flowchart showing the standardization of the database;

FIG. 4 demonstrates an exemplary Persona+Trait Test;

FIG. 5 demonstrates an exemplary Persona+Category Test;

FIG. 6 is a flowchart showing the process performed in order to execute a product research;

FIG. 7 demonstrates an exemplary Brand Test;

FIG. 8 demonstrates an exemplary Brand Personality (Trait) Report; and

FIG. 9 demonstrates an exemplary Brand Perception (Category) Report.

### DETAILED DESCRIPTION OF THE EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

For the purpose of the present invention a “respondent” or a “user” is an individual whose thoughts are being elicited by the system of the present invention. A “researcher”, a “marketer” or a “customer” is a marketing professional or a client of the system of the present invention.

In the context of the present invention the terms “product” “brand” and “service” are used interchangeably.

In preferred embodiments of the present invention, a method and system for generating marketing research are provided. The method and system use scientifically based research technology in the field of consumer behavior and marketing research. The method overcomes limitations of current marketing tools and improves the understanding of a consumer's decision making process. The technique is able to reveal a respondent's subconscious thoughts about a product, service, brand and other marketing variables, thus providing marketing professionals with an effective marketing research tool. The method's process provides a series of steps, performed by the system, for eliciting subconscious thoughts of a respondent regarding marketing input. A respondent interacts with the system and an algorithm(s) analyses his or her responses, performs aggregation and statistical analysis of all of the data created by individual respondent and provide output in convenient quantitative and graphical forms. This output can be used to guide marketing professionals in the creation of marketing strategy and campaigns (marketing tool).

The subconscious mind is a widely distributed neural network of interconnected nodes or neurons, formed by association, which contains our experiences in their connectional structure (Kahneman, 2013; Osada et al., 2008). Unlike the conscious mind that works in sequence, the mechanism of the subconscious associative network is parallel (Kahneman, 2013). When a particular idea has been activated, it triggers many other ideas which in turn activate others. This process is automatic and rapid that occurs with no voluntary control, whereas only a small portion of activated images reaches our conscious mind.

The proposed method creates a database of standardized visual stimuli for activating associative neural network and eliciting subconscious thoughts. The architecture of the database resembles associative multi-layer neural network structure (Carperner, 1989), whereas stimuli that comprise the database are photographs of human being. Associations that the stimuli elicit are validated by a large number of respondents and are used then as a standardized measuring tool for human associations. On the basis of the database, the system creates easy and quick visual tests for eliciting consumers' subconscious thoughts. In these tests respondents are asked simple and quick visual questions about the stimuli, people on the photographs, and a brand, a product or a service.

The idea behind choosing human images as a stimulus is based on an extensive psychological and brain research that suggests that personal appearance has a strong impression on others (Berry, 1990). Static appearance, especially of human faces, evokes a wide range of associations and attitudes in perceivers (Berry & McArthur, 1986). Furthermore, respondents exhibit high consensus in their impressions of other people even when their judgments are based on physical appearance alone (Zebrowitz et al., 1993). Since attitudes and stereotypes can be activated automatically without the conscious control of the perceiver (Devine, 1989), a method for analysis of attitudes that is based on human images is able to access a respondents' subconscious thoughts (Axelrod et al., 2015). Furthermore, visual and indirect nature of the tests enables bypassing conscious biases that usually influent respondents' answers to direct questions (Fisher, 1992). Thus, the proposed method provides marketing professionals with consumers' subconscious thoughts and attitudes towards a brand.

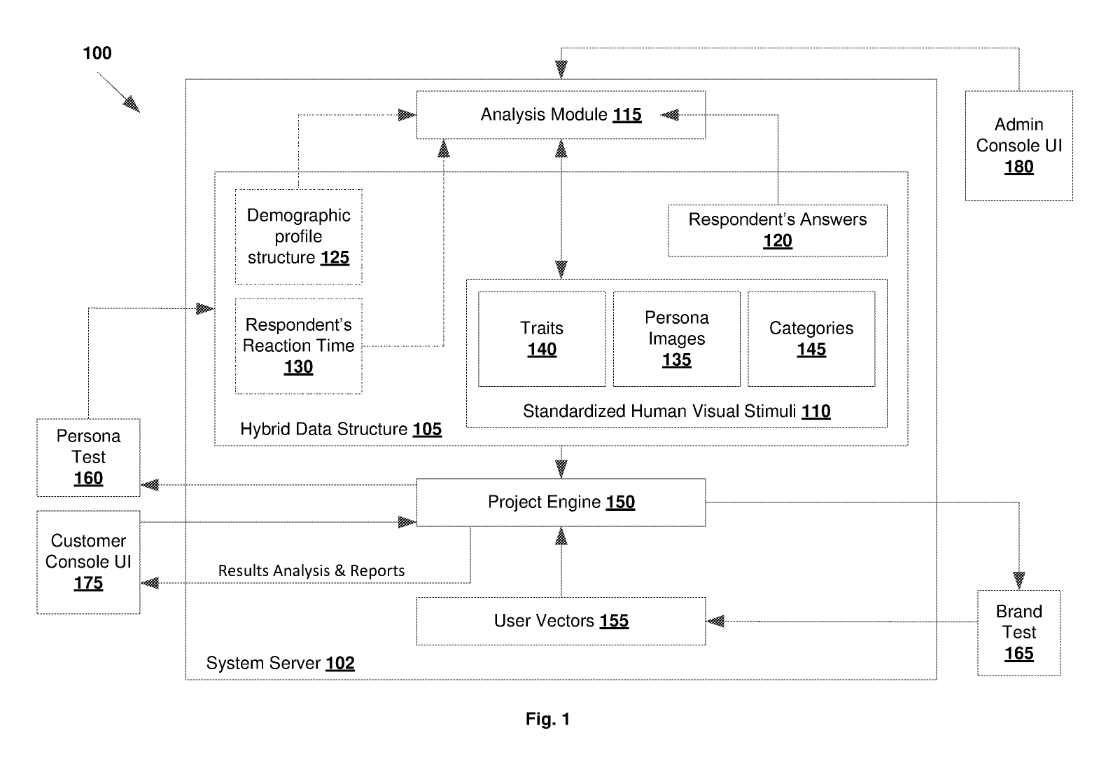

Reference is now made to FIG. 1 which is a schematic view of the system 100 according to embodiments of the present invention. The system 100 comprises a system server 102 comprising a Hybrid Data Structure 105 comprising a Standardized Human Visual Stimuli Database 110 connected with an Analysis Module 115 which is connected with Respondent's Answers 120 and optionally with a Demographic Profile Structure 125 and Respondent's Reaction Time 130. The Standardized Human Visual Stimuli Database 110 comprises Persona Images 135, Traits 140 and Categories 145. The system server 102 further comprises a Project Engine 150 connected with the Hybrid Data Structure 105, User Vectors 155, a Persona Test module 160 and a Brand Test module 165. The Persona Test module 160 is also connected with the Hybrid Data Structure 105. The Brand Test module 165 is also connected with the User Vectors 155. The Customer Console UI 175 is connected with the Project Engine 150. The system 100 further comprises an Admin Console UI 180 connected with the system server 102.

The system 100 may include one or more processing units (CPUs) for executing software modules, programs, or instructions stored in a memory (Database) and thereby performing processing operations. The memory may include high-speed random access memory, such as dynamic random-access memory (DRAM), static random-access memory (SRAM), double data rate random-access memory (DDR RAM), or other random-access solid state memory devices. Additionally, the memory may include non-volatile memory, such as one or more magnetic disk storage devices, optical disk storage devices, flash memory devices, or other non-volatile solid state storage devices. The memory may optionally include one or more storage devices remotely located from the CPU. The memory, or alternately the non-volatile memory device within the memory, may be or include a non-transitory computer-readable storage medium.

According to embodiments of the invention, the Persona Test 160 and the Brand Test 165 may run on a computing device such as a computer, smartphone, tablet, etc. which may be wired or wirelessly connected to the System Server 102. The computing device may comprise a display and a GUI (Graphical User Interface) enabling a user to interact with the computing device.

The Hybrid Data Structure 105 comprises all data regarding all individual respondents that are using the Persona Test. It includes the following information about the respondents:
1. The Respondent's answers 120 to visual questions of the Persona Test 160.
2. Optionally the Respondent's demographic profile 125. The demographic profile structure 125 is an n-dimensional vector that includes respondents' demographic data such as: age, gender, residence, education level, socio-economic profile, etc.
3. Optionally the Respondent's reaction times 130, i.e. the time duration from the appearance of the stimulus on the screen until a respondent's answer.

The core element of the present invention is the Standardized Human Visual Stimuli Database 110 (referred to hereinafter also as the Database). The Database is used as a standardized measuring tool for human associations in an associative network of the respondent's subconscious mind.

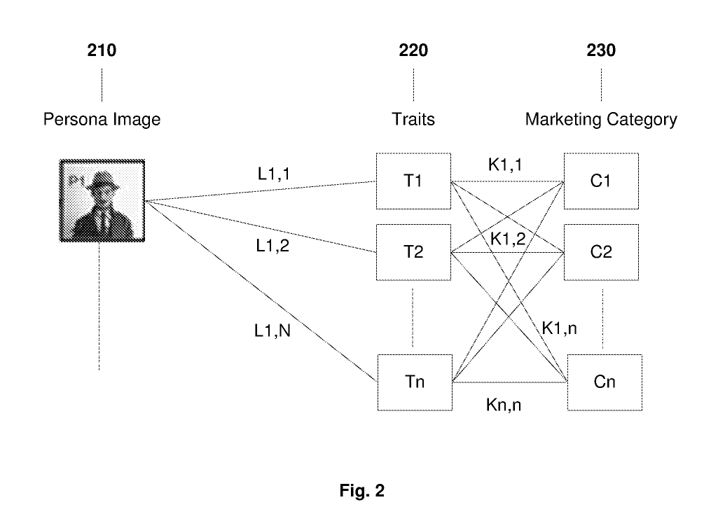

The Standardized Human Visual Stimuli Database 110 includes three layers as shown in FIG. 2:
A. A Persona Layer 210 that comprises a large set of human visual stimuli, such as a set of photographs of ordinary people in natural daily situations across a wide range of human behavior (Persona Images 135).
B. A Trait Level 220 that comprises a list of human psychological traits (140) associated with each Persona Image of the Persona Layer 210. For example, a strong association between Persona Image ‘A’ and a Trait “introvert” means that that particular person in the photograph is perceived as an introvert. Each Persona Image is associated with at least one Trait.
   The list of Traits is based on the Big Five personality model (Goldberg, 1993) and other psychological models in order to construct an exhaustive list of human psychological Traits.
C. A Marketing Category Level 230 (referred to hereinafter also as the Category Level) that comprises a list of products' marketing characteristics (145). This list is constructed in collaboration with marketing professionals and according to product's categories that they are interested to measure. For example, it is possible that marketers would like to measure the following categories of a product Coca Cola™: healthy, young, happy etc.
   The structure of the Database 110 mimics the structure of the associative neural network (Fuster, 1997). Each node in the Persona Layer 210 is connected to each node in the Trait Layer 220, whereas each node in the Trait Layer is also connected to each node in the Category Layer 230. The Strengths of connections between the layers, referred to hereinafter also as the Associative Weights, are measured and standardized by a large number of respondents as explained below.

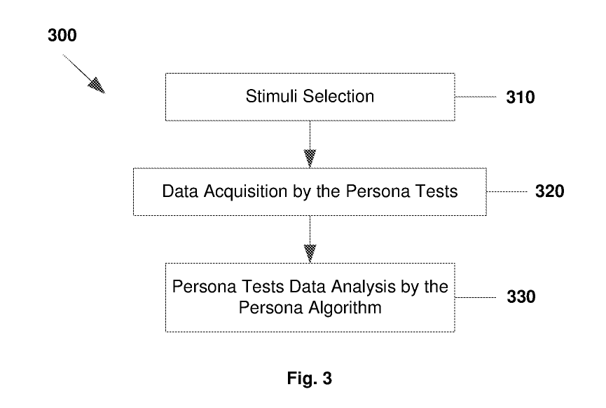

FIG. 3 is a flowchart 300 showing the standardization of the database 110.

### Step 310—Stimuli Selection

Persona Images are selected apriori for the Database according to the following criteria:
a. Each stimulus has to be a relatively high quality photograph of a person.
b. Only one person appears in each photograph.
c. The face and eyes of a person in each photograph are clearly seen (e.g., no sunglasses).

d. Each person is photographed in a natural, i.e., not staged, pose or posture and in a natural, ecological environment.

### Step 320—Data Acquisition

Data acquisition for standardization of the Database is performed by the quick and easy visual tests that are generated by the system and can be performed online. These visual tests are the Persona Tests 160. In Persona Tests respondent's thoughts about Persona Images are collected. Demographical questions regarding respondent's gender, age, place of living etc. and/or respondent's reaction times can be added to these tests.

In order to measure connections between the layers of the Database, two kinds of Persona Tests have to be performed: (1) Persona+Trait Test, where a Persona Image is presented to respondents along with a Trait, and (2) Persona+Category Test, where a Persona Image is presented to respondents along with a Marketing Category. The first one measures Associative Weights between the Persona Layer and the Traits Layer, whereas the aim of the second one is to measure Associative Weights between the Trait Layer and the Marketing Category Layer.

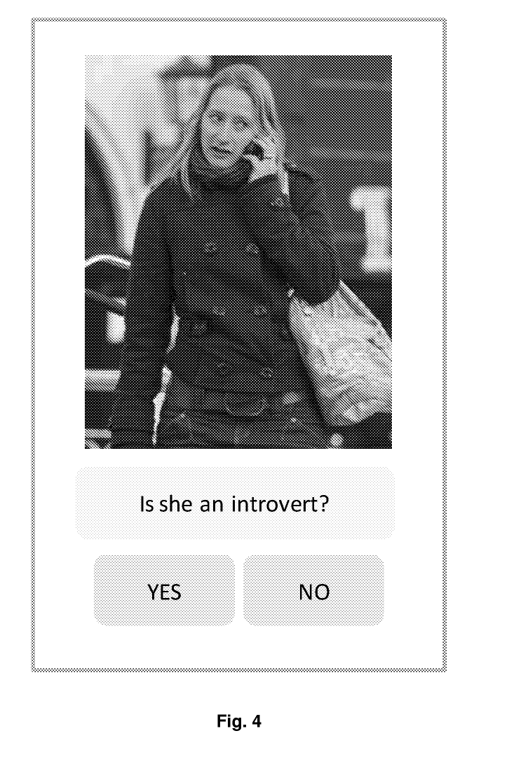

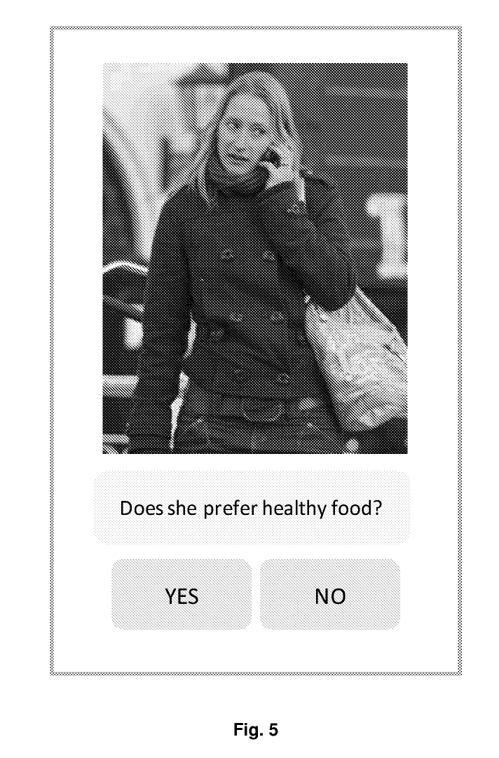

Persona Tests 160 are created according to the following rules:
1. In Persona+Trait Test, a Persona Image appears on a respondent's computer or mobile screen along with one Trait and the respondent is asked whether the person in the photograph possesses this particular Trait.
   In Persona+Category Test, a Persona Image appears on a respondent's computer or mobile screen along with one Category and the respondent is asked whether the person in the photograph is used to acquire that particular type of products. Other type of questions such as “whether the person in the photograph likes healthy food” can be used also.
2. The respondent is instructed to answer ‘Yes’ or ‘No’ to a question on a screen.
   FIG. 4 demonstrates an exemplary Persona+Trait Test.
   FIG. 5 demonstrates an exemplary Persona+Category Test.
3. According to embodiments of the invention, only one Persona Image along with one Trait or one Category appears on the screen each time.
4. A stimulus along with a Trait/Category name remains on the screen until a respondent's answer.
5. According to embodiments of the invention, after the respondent answers the visual question (e.g. presses one of the two response buttons) the Persona Image or/and the Trait (or Category) switch to another Persona Image or Trait (or Category) accordingly, but the instructions remain the same.
6. According to embodiments of the invention, each respondent answers a small number of visual questions only.
7. The Persona Tests can be stopped any time. There is no need for a respondent to answer all test questions regarding all Persona Images and/or all Traits or Categories.
8. The respondent's behavioral data (i.e., their answers to visual questions), his or her reaction times (the time duration from the appearance of the stimulus on the screen until a respondent's answer) and demographical data are stored digitally in the Hybrid Data Structure 105.

### Step 330—Persona Tests Data Analysis

After the aggregation of the respondents' data in the Hybrid Data Structure (answers to Persona Tests, respondents' reaction times and respondents' demographical data), the data is analyzed by the Persona Algorithm in order to standardize the Human Visual Stimuli Database by large number of respondents. For the purpose of standardizing the database the algorithm calculates Associative Weights or strength of connections between each Persona Image and each Trait by analyzing Persona+Trait Tests. In addition, the algorithm calculates Associative Weights between each Trait and each Category by analyzing Persona+Category Tests as will be explained below.

1. Persona+Trait Test Analysis. This Persona Algorithm calculates Associative Weights between Persona Images and Traits according to the following steps:
a. Each pair (one Persona Image and one Trait) is presented to respondents. According to embodiment of the invention, each pair is presented to at least forty respondents (a sufficient number of respondents for statistical analysis of the test). It will be appreciated that the present invention is not limited to this number of respondents.
b. Respondents' answers are aggregated in the Hybrid Data Structure 105.
c. According to embodiments of the invention, respondent's reaction time is measured in order to optionally filter too fast and/or too slow answers. The reaction time provides information regarding a respondent's certainty level (confidence or conviction) in his or her answer.
d. According to embodiments of the invention, Associative Weight between each Persona Image and each Trait is calculated by the following definition:
   Associative Weight_{Persona+Trait}=a proportion of the respondents that gave a positive answer to a Persona+Trait question.
   For example, if 75% of respondents gave a positive answer to a visual question regarding a possession of a Trait “introvert” by a Persona Image ‘A’, the associative weight between the Persona Image ‘A’ and the Trait “introvert” is equal to 0.75.

2. Persona+Category Test Analysis. This Persona Algorithm calculates Associative Weights between Traits and Marketing Category according to the following steps:
a. Each pair (one Persona Image and one Category) is presented to respondents. According to embodiment of the invention, each pair is presented to at least forty respondents (a sufficient number of respondents for statistical analysis of the test). It will be appreciated that the present invention is not limited to this number of respondents.
b. Respondents' answers are aggregated in the Hybrid Data Structure 105
c. Respondent's reaction time is measured in order to optionally filter too fast and/or too slow answers. The Reaction time provides information regarding a respondent's certainty level (confidence or conviction) in his or her answer.
d. Associative Weights between each Persona Image and each Category is calculated by the following definition:
   Associative Weight between Persona and Category=a proportion of the respondents that gave a positive answer to a Persona+Category question.
   e. Associative Weights between each node in the Trait Layer and each node in the Category Layer are calculated mathematically by dividing the Associative Weight between the Persona Image and the Category by the Associative Weight between the Persona Image and the Trait as can be seen in the following formula:

AW_{Trait+Category}=AW_{Persona+Category}/AW_{Persona+Trait}
AW_{Trait+Category}—is an associative weight between a specific Trait and a specific Category.
AW_{persona+Trait}—is an associative weight between a specific Persona Image and specific Trait (a proportion of positive answers to a Persona+Trait Test).
AW_{Persona+Category}—proportion of respondents that answered positively to a question regarding the connection between the Persona Image and the Category.

After the Database's standardization by respondents is completed, the database can be used as a measuring tool for consumer's subconscious associations about a brand or product.

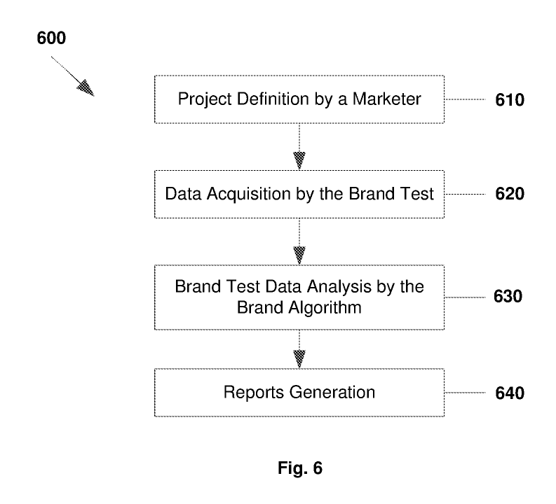

FIG. 6 is a flowchart 600 showing the process performed in order to execute a product research.

### Step 610—Project Definition—definitions of visual tests for evaluation of consumer's subconscious thoughts about a product or a brand

In this step a marketer defines initial conditions of a visual test for evaluation of consumers' thoughts regarding a product. These definitions include a Target Product, Test Question(s), a Target Population and Target Category\Categories. A Target Product is a product or brand that is being analyzed by the system of the present invention. A Target Population is a population of potential consumers of a Target Product as it is defined by a marketer (a customer who uses the system). Respondents' characteristics are defined according to the marketer's Target Population definition. Target Categories are a list of Marketing Categories that a marketer is interested to explore (e.g., healthy, dietetic etc.).

For example, if the goal of a study is to reveal consumers' subconscious thoughts regarding Coca Cola™ and to compare them to the consumers' thoughts regarding Pepsi Cola™, Coca Cola™ would be a primary target product and Pepsi Cola™ would be a secondary target product. The target population can be potential consumers of both beverages.

A Test Question depends on the research topic. No direct questions about a respondent's personal opinions are asked. Rather, Test Question refers to a respondent's thoughts about a person in a given photograph, i.e. association between Persona Image and a Trait or Marketing Category.

In the above example the following two questions may be asked: (1) “Does the person in the photograph like to drink Coca Cola™?” The answer being selected from the options: ‘yes’ or ‘no’. Or: (2) “Which drink does the person in the photograph prefer, Coca Cola™ or Pepsi Cola™?” The answer being selected from the options: ‘Coca Cola™’ or ‘Pepsi Cola™’.

When a marketer defines a project, the Persona Algorithm takes individual respondents' data from the Hybrid Data Structure 105 of FIG. 1 of a particular Demographic Segment according to the marketer's definition of the target population, analyzes it and returns Associative Weights between the layers of that particular Database Segment. The output of the algorithm is a segment of Database that is used by the Brand Algorithm for Brand Personality (Trait) and Brand Perception (Category) calculations.

### Step 620—Visual Tests for Evaluation of consumer's subconscious thoughts about Product or Brand

In this step respondents' thoughts about a Target Product are measured by visual tests that are generated automatically by the system according to the test's definitions (Step 610). The aim of these tests is to acquire respondents' behavioral data and respondents' reaction times for measuring respondents' subconscious thoughts about a target product. These visual tests are Brand Tests 165. Demographical questions regarding respondent's gender, age, place of living etc. can be added to these tests.

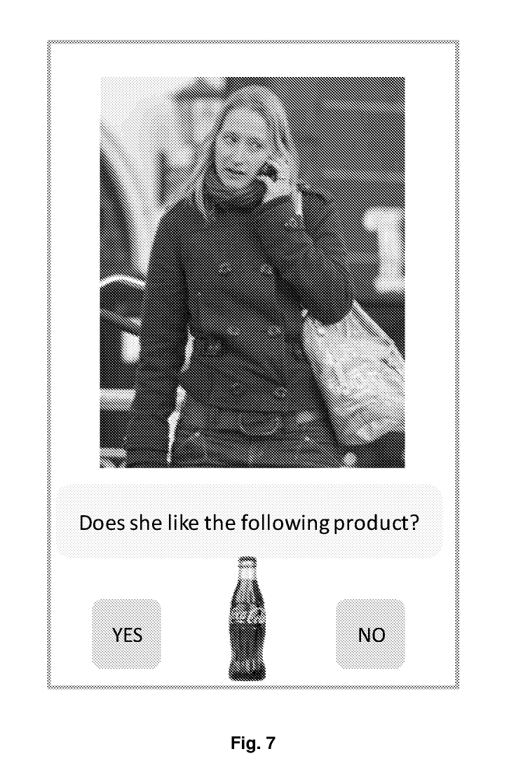

FIG. 7 demonstrates an exemplary Brand Test.

Brand Tests are created according to the following rules:
a. In these tests a Persona Image and a Target Product appear on a respondent's computer or mobile screen along with a Test Question, and a respondent is instructed to answer that question.
b. According to embodiments of the invention, only one Persona Image along with one Test Question appears on the screen each time.
c. The respondent is instructed to choose one answer from two different options, for example: ‘Yes’ or ‘No’.
d. A stimulus along with a question remains on the screen until a respondent's answer. After a respondent answers the visual question (e.g. presses one of the two responses buttons), e.g. another Persona Image along with the same Test Question appears on the screen, another Test Question along with the same Persona Image appears on the screen, etc.
e. According to embodiments of the invention, each respondent answers a small number of visual questions only.
f. The visual Brand Test can be stopped any time. There is no need for a respondent to answer all the Test Questions regarding all Persona Images.
g. Respondent's behavioral data (i.e., their answers to a Brand Test Questions), his or her reaction times (the time duration from the appearance of the stimulus on the screen until a respondent's answer) and demographical data are stored digitally in a User Vector. The User Vector 155 of FIG. 1 is an aggregation of all data regarding all respondents to a Brand Test. It includes respondents' answers to visual questions and optionally respondents' reaction times and respondents' demographical data.

### Step 630—Brand Test Data Analysis

After the aggregation of the respondents' data in the User Vector 155, the data is analyzed by the Brand Algorithm. The algorithm calculates target population's subconscious thoughts about a target product, using a Segment of the standardized Database 110, and creates reports based on this analysis.

The aim of the Brand Algorithm is to analyze Brand Tests in order to measure Brand Personality (Traits) and Brand Perception (Categories) for a marketer. The Algorithm analyses individual respondent's data, performs statistical analysis of all of the data created by individual respondents and provides two outputs for the marketer: (1) Brand Personality Report (based on Traits) and (2) Brand Perception Report (based on Marketing Categories).

The Brand Algorithm comprises the following steps:
a. According to embodiments of the invention, respondent's reaction time is analyzed. Too fast and/or too slow answers are may optionally be filtered from the analysis. Reaction time provides information regarding a respondent's certainty level (confidence or conviction) in his or her answer.
b. Regarding each Persona Image, proportion of respondents who gave a positive answer to a visual question about an association between the Persona and a Target Product is measured.
c. Calculation of Traits' Power Values, e.g. by the multiplication of Associative Weights between the Persona Image and the Trait and the proportion of the respondents to the Brand Tests that gave a positive answer to a question regarding the association between the Persona and the target object:

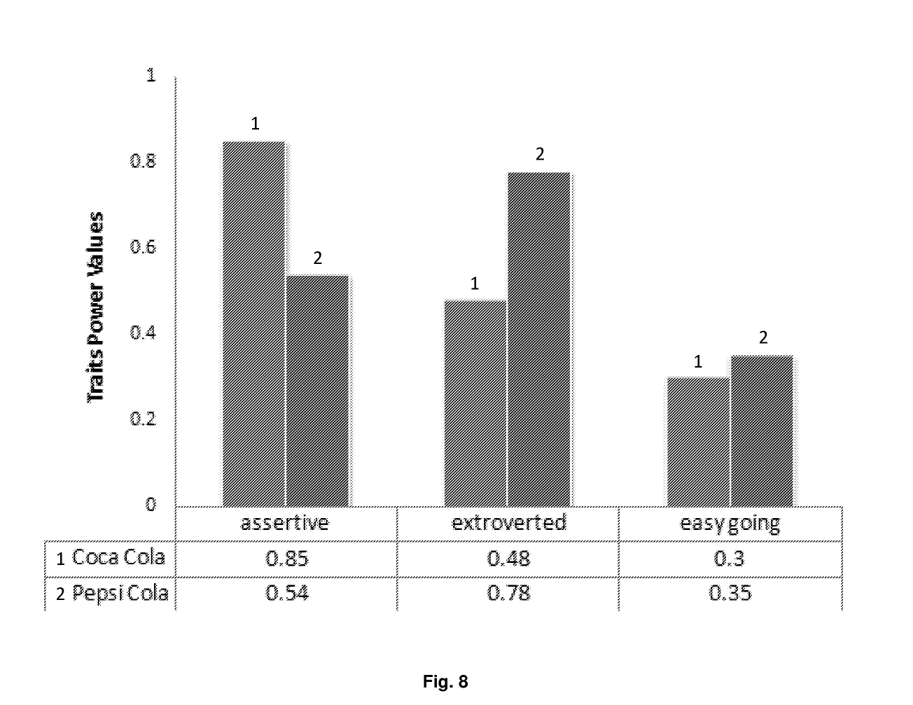

Trait Power Value=AW_{persona+Trait}*Proportion_{Persona+Target Object}
AW_{persona+Trait}—is an associative weight of Persona Image and the Trait (a proportion of positive answers to a Persona+Trait Test).
Proportion_{Persona+Target Object}—proportion of respondents who answered positively to the Brand Test (a question regarding the connection between the Persona Image and the target object).
d. Calculation of averaged Power values of the Traits. Since all Persona Images contribute to Power level of each Trait, there is a need to calculate weighted mean of the Power level of each Trait. Not all Persona Images and not all respondents' answers contribute equally to a final Power score: certain respondents' answers (based on respondents' reaction time analysis) and unambiguous association weights (based on all respondents proportion analysis, whereas association weights close to zero or to 1 are unambiguous and proportions close to 0.5 are inconclusive) will receive more weight than uncertain and ambiguous results (association weights between Persona Image and Trait that are close to 0.5).
e. Brand Personality (Trait) Report creation—the report is a graphical as well as a quantitative representation of the results. It includes a list of all Traits and their averaged Power Values as well as a bar graph of the Traits where the Y axis is the Traits' averaged Power and the X axis is the list of Traits. For example, FIG. 8 shows a primary target product—Coca Cola™ (1), and a secondary target product—Pepsi Cola™ (2). The Brand Personality (Traits) Report shows respondents thoughts about each of the products and a quantified comparison between them. As shown in the example of FIG. 8, Coca Cola™ consumers were found to be perceived as more assertive but less extroverted than Pepsi Cola™ consumers.
f. Calculation of Marketing Categories' Power Values, e.g. by the multiplication of Associative Weights between the Persona Image and the Trait, the Associative Weights between the Trait and the Category, and the proportion of the respondents to the Brand Tests that gave a positive answer to a question regarding the association between the Persona and the target object:

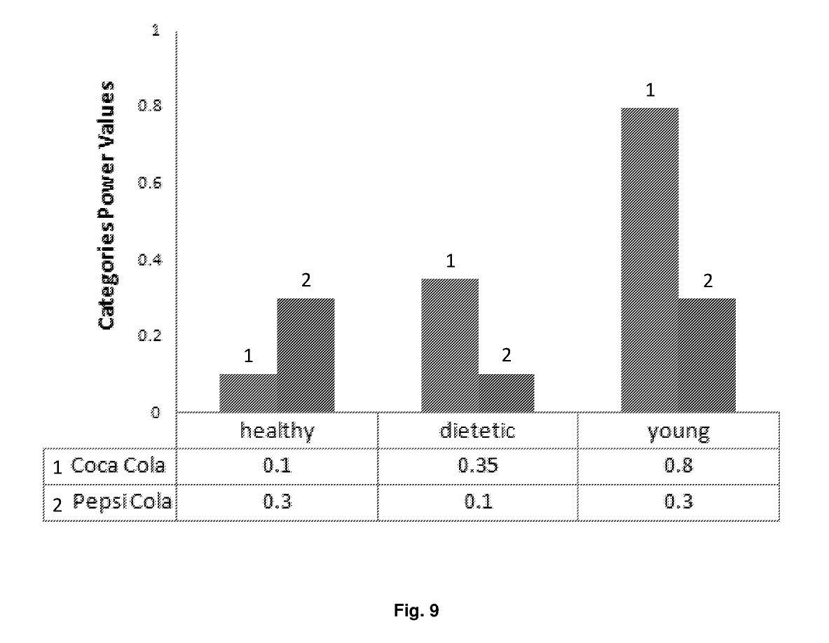

Category Power Value=AW_{persona+Trait}*AW_{Trait+Category}*Proportion_{Persona+TargetObject}
AW_{persona+Trait}—is an Associative Weight between a Persona Image and a Trait, as it was calculated previously by the Persona Algorithm of Persona+Trait Tests.
AW_{Trait+Category}—is an Associative Weight between the Trait and the Category as it was calculated previously by the Persona Algorithm of Persona+Category Tests.
Proportion_{Persona+Target Object}—proportion of respondents who answered positively to a question regarding the connection between the Persona Image and the target object in a Brand Test.
g. Calculation of averaged Power values of Categories. Since all Persona Images and all Traits contribute to Power values of each Category, there is a need to calculate weighted mean of the Power value of each Category.
   Persona Images, Traits and respondents' answers contribute unequally to a final Power score: certain respondents' answers (based on respondents' reaction time analysis) and unambiguous association weights (based on all respondents proportion analysis, whereas association weights close to zero or to 1 are unambiguous and proportions close to 0.5 are inconclusive) will receive more weight that uncertain and ambiguous results (association weights that are close to 0.5).
h. Brand Perception (Category) Report creation—the report is a graphical as well as a quantitative representation of the results (e.g. FIG. 9). It includes a list of Marketing Categories that were ordered by the marketer and their averaged power values.

In the following simplified example, 60% of respondents gave a positive answer to a visual question regarding a possession of a Trait “introvert” by a Persona Image ‘A’. Thus, the associative weight between the Persona Image ‘A’ and the Trait “introvert” is equal to 0.6. If 50% of respondents gave a positive answer to the question: “Does the person in the photograph like to drink Coca Cola™?” regarding Persona Image ‘A’, the associative weight between the Persona Image ‘A’ and Coca Cola™ is equal to 0.5. Now, the system may draw a conclusion regarding perception of Coca Cola™'s consumers. In this case the power value of the Trait “introvert” is equal to 0.3 (0.6*0.5), (The scale is from 0 to 1, whereas 0=is perceived not introvert at all, 1=is perceived as a total introvert, 0.5=inconclusive results). In other words, Coca Cola™'s consumers are perceived by the respondents as slightly not introverts.

In another simplified example, if (a) 40% of respondents gave a positive answer to a visual question regarding a possession of a Trait “perfectionist” by a Persona Image ‘B’, (b) the associative weight between the Trait “perfectionist” and the Marketing Category “dietetic product” is equal to 0.3 (meaning that 30% respondents think that perfectionist people like to purchase dietetic products), and (c) 80% of respondents gave a positive answer to the question: “Does the person in the photograph like to drink Coca Cola™?” regarding Persona Image ‘B’, the Power alue of the Category “perfectionist” is equal to 0.096 (0.4*0.3*0.8). Since the scale of categories' power values runs from 0 to 1, the system may conclude that the beverage Coca Cola™ is perceived by the target population as not dietetic.

### Step 640—Reports Generation

As mentioned above there are two kinds of reports which are created by the Brand Algorithm and presented to the marketer who ordered the research:
1. Brand Personality (Trait) Report—based on the Trait Layer of the Database. It is an aggregation of all the data created by individual respondents from the target population who have used the Brand Test of the system of the present invention. It is a quantitative as well as graphical representation of the results. The report reveals measured and quantified subconscious perception of the target product's personality as it is perceived by the respondents. It included a list of psychological Traits and the Power values of these Traits that respondents believe the brand's consumers possess.
   It is noteworthy to mention that this report does not provide information about the actual beverage's consumers, but only about the perceived consumers. In other words, a Brand Personality Report reveals a population's subconscious thoughts or associations about the target product's audience.
2. Brand Perception (Category) Report—an end product of the process. It is based on the Marketing Category Layer of the Database. The report is an aggregation of all the data created by individual respondents from the target population who have used the Brand Test of the system of the present invention. It is a quantitative as well as graphical representation of the results. A Brand Perception Report comprises a list of Marketing Categories and their Power values, thus reveals measured and quantified subconscious perception of the respondents regarding the target product.

A Brand Personality and a Brand Perception Reports reveal consumers' subconscious thoughts about a product or brand, which can facilitate effective marketing programs. They provide marketing professionals with rich data regarding subconscious consumers' thoughts about a product, thus enabling more effective and focused marketing campaigns. Marketing activity can then be derived from this marketing information.

It will be appreciated that the Standardized Human Visual Stimuli Database may be implemented independently of the Brand Test. The Standardized Human Visual Stimuli Database is a tool upon which the Brand Test may be constructed. Thus, the same Standardized Human Visual Stimuli Database can be used for different marketing studies to answer different marketing questions.

The methods according to the present invention, while specific to marketing analysis, are not limited to such tasks. For example, the system of the present invention may be used in the field of political campaigns. Instead of a product or brand, a political candidate or political party can be analyzed by the present invention. In this case the subconscious thoughts about a political candidate or political party would be elicited by the system.

According to embodiments of the invention, the Project Engine 150 of FIG. 1 may perform efficient selection of Persona Images for a Brand Test. After a Brand Test is defined by a marketer, the Project Engine may calculate probability for each Persona Image to be selected in the Test.

The Project Engine is responsible for a Brand Test's initiation and cessation as well as for Persona Images selection for a Brand Test. In addition, the Engine may initiate Persona Tests in case there is not enough information in the Database regarding the target population.

According to embodiments of the invention, the Project Engine 150 may perform the Brand Test analysis as explained above.

The cardinal element of the system is the sequence of events that are handled from the moment a new Test is requested, until this cycle is complete, as following:
1. Project Definition—a marketer, who orders a project, defines a target population (as explained above in Step 610).
   Relevant profiles extraction—the system looks for individual respondents' data in the Hybrid Data Structure 105 that are similar to the target population according to their demographic data. According to embodiments of the invention the system may use respondents' data that are close to the target population.
2. Persona Tests Initiation—If there is not enough data in the Database to run a Brand Test, the system initiates and runs Persona Tests according to the Categories defined by the marketer.
3. Database Segment Creation—Database Segment is a part of the Database that includes information relevant to the target population only. In other words, Associative Weights between the Layers of the Database are calculated using the data of respondents to Persona Tests from the relevant population only.
   After completing the missing information in the Database, a Database Segment is created ad hoc. Relevant respondents' profiles are used to calculate a Database Segment by the Persona Algorithm for the particular target population.
4. Data analysis of the data accumulated in the User Vector is performed then using the Database Segment.
   A Database Segment enables accurate analysis of the Brand Tests results according to the associations of the population that closely resembles the target population.

The Customer or Marketer Console UI 175 of FIG.1 enables a marketer to define a project and receive reports after the project is completed.

According to embodiments of the present invention, the Customer or Marketer Console UI 175 is a web app including:
account configuration
test initiation
test management console (a list of running/complete tests with progress indications of the tests)
test reports

The Admin Console UI (180 of FIG. 1) enables system management. For example, admin can add or remove Persona Images from the system.

According to embodiments of the present invention, the Admin Console UI 180 is a web app including:
User management.
Customer/account management.
Constant adjustment (enabling admin to tweak computational values in the system).
Persona management (image upload, Trait management).
Dashboard.

It will be appreciated by persons skilled in the art that the present invention is not limited to what has been particularly shown and described hereinabove. Rather the scope of the present invention is defined by the appended claims and includes combinations and sub-combinations of the various features described hereinabove as well as variations and modifications thereof which would occur to persons skilled in the art upon reading the foregoing description.

### REFERENCES

Axelrod, Bar & Rees, 2015. Exploring the unconscious using faces. Trends in Cognitive Sciences, 19 (1): 35-45.

Bargh, J. A. (2002). Losing consciousness: automatic influences on consumer judgment, behavior, and motivation. Journal of Consumer Research, 29: 280-285.

Berry, D. S., (1990). Taking people at face value: evidence for the kernel of truth hypothesis. Social Cognition, 8: 343-361.

Berry, D. S., & McArthur, L. Z. (1986). Perceiving character in faces: The impact of age-related craniofacial changes on social perception. Psychological Bulletin, 100: 3-18.

Boddy, C. R. (2004). From brand image research to teaching assessment: using a projective technique borrowed from marketing research to aid an understanding of teaching effectiveness. Journal of Quality Assurance in Education, 12: 94-105.

Boddy, C. R. (2005). Projective techniques in market research: valueless subjectivity or insightful reality? A look at the evidence for the usefulness, reliability and validity of projective techniques in market research. International Journal of Market Research, 47: 239-54.

Boddy, C. R. (2007). Projective techniques in Taiwan and Asia-Pacific market research. Qualitative Market Research: An International Journal, 10: 48-62.

Carperner, G. A., (1989). Neural network models for pattern recognition and associative memory. Neural Networks, 2: 243-257.

Chartland, T. L. (2005). The role of conscious awareness in consumer behavior. Journal of Consumer Psychology, 15: 203-210.

Devine, P. G. (1989). Stereotypes and prejudices: their automatic and controlled components. Journal of Personality and Social Psychology, 56: 5-18.

Dijksterhuis, A., Smith, P. K., van Baaren, R. B., Wigboldus, D. H. J. (2005). The unconscious consumer: effects of environment on consumer behavior. Journal of Consumer Psychology, 15: 193-202.

Fisher, R. (1992). Social desirability bias and the validity of indirect questioning. Journal of Consumer Research, 20 (2): 2013-385.

Fuster, J. M. (1997). Network memory. Trends in Neuroscience, 10: 451-459.

Goldberg, L. R. (1993). “The structure of phenotypic personality traits”. American Psychologist 48: 26-34.

Haire, M. (1950). Projective techniques in marketing research. Journal of Marketing, 14: 649-656.

Kahneman, D. (2013). Thinking, Fast and Slow. Farrar, Straus and Giroux: New York.

Lilienfeld, S. O., Wood, J. M. & Garb, H. N. (2000) The scientific status of projective techniques. Psychological Science in the Public Interest, 1:27-66.

Morwitz, V. G., Steckel, J. H., & Gupta. A. (1997). When do purchase intentions predict sales, Report No. 97-112, Working Paper Series, Marketing Science Institute.

Osada, T., Adachi, Y., Kimura, H. M., & Miyashita, Y. (2008). Towards understanding of the cortical network underlying associative memory. Philosophical Transactions of the Royal Society B, 363: 2187-2199.

Puccinelli, N. M., Braun, K., Mast, F., & Zaltman, G. (2001). Implicit predictors of consumer behavior, Case No. 502-043, Harvard Business School.

Weiser, J. (1988). See what I mean? Photography as nonverbal communication in cross-cultural psychology. In Cross-Cultural Perspective in Nonverbal Communication, 245-290. Lewiston, N.Y./Toronto: C. J. Hogrefe.

Winkielman, P., & Berridge, K. C. (2004). Unconscious emotion. Current Directions in Psychological Science, 13: 120-123.

Zalman, G. (1997). Rethinking market research: putting people back in. Journal of Marketing Research, 24: 424-437.

Zaltman, G. (2003). How Customers Think: Essential Insights into the Mind of the Market. Harvard Business School Press: USA.

Zebrowitz, L. A., Montepare, J. M., & Lee, H. K. (1993). They don't all look alike: Individual impressions of other racial groups. Journal of Personality and Social Psychology, 65: 85-101.

1. A system for generating marketing research, comprising:
a database configured to store a plurality of traits, at least one category and a plurality of human visual stimuli each comprising a person image;
a display configured to present selected ones of said stimuli and at least one test question associated with a target product or service to a plurality of first respondents;
GUI means configured to enable said first respondents to answer said at least one test question; and
a processor configured to analyze said first respondents' answers to said at least one test question and use said database to indirectly reveal consumers' thoughts about said target product or service and create at least one report of a target population for said target product or service that can be used as a marketing tool.

2. The system of claim 1, further comprising a plurality of Persona Tests and said database further comprises first weights between said selected ones of said stimuli and at least part of said plurality of traits, second weights between said selected ones of said stimuli and at least one of said at least one category and third weights between said at least part of said plurality of traits and said at least one of said at least one category.

3. The system of claim 2, wherein said plurality of Persona Tests comprise a plurality of Persona-trait Tests and a plurality of Persona-category Tests.

4. The system of claim 3, wherein each one of said plurality of Persona-trait Tests comprises a stimulus comprising a person image, a trait and a trait question associating said trait and said person image; and wherein each one of said plurality of Persona-category Tests comprises a stimulus comprising a person image, a category and a category question associating said category with said person image.

5. The system of claim 4, further comprising an analysis module configured to analyze answers of a plurality of second respondents to said plurality of trait questions and to said plurality of category questions, thereby determining said first, second and third weights corresponding to said person image.

6. The system of claim 5, wherein said selected stimuli are selected from said plurality of human visual stimuli according to a demographic profile of each second respondent who answered a question regarding said stimuli.

7. The system of claim 6, wherein said demographic profile comprises at least one of age, gender, residence, education level and socio-economic profile.

8. The system of claim 5, wherein said selected stimuli are selected from said plurality of human visual stimuli according to a reaction time of each second respondent who answered a question regarding said stimuli.

9. The system of claim 5, wherein the value of each of said first weights is equal to the proportion of second respondents who gave a positive answer to one of said traits questions related to said selected stimuli; and wherein the value of each of said second weights is equal to the proportion of second respondents who gave a positive answer to one of said category questions related to said selected stimuli.

10. The system of claim 9, wherein the value of each of said third weights is equal to the division of a second weight and a respective first weight corresponding to the same person image.

11. (canceled)

12. (canceled)

13. (canceled)

14. A method of generating marketing research, comprising:
defining a research comprising a target product or service, target population, at least one marketer category and at least one test question associated with said target product or service;
selecting a plurality of human visual stimuli each comprising a person image from a database comprising a plurality of human visual stimuli;
presenting said selected plurality of human visual stimuli and said target product or service along with said at least one test question to a plurality of first respondents;
analyzing said first respondents' answers to said at least one test question to indirectly reveal said first respondents' thoughts about said target product or service; and
creating at least one report based on said analysis thereby providing information about said target product or service that can be used as a marketing tool.

15. The method of claim 14, wherein said database further comprises a plurality of traits, at least one category, first weights between each person image and each of said plurality of traits, second weights between each person image and each of said at least one category and third weights between each of said plurality of traits and each of said at least one category.

16. The method of claim 15, further comprising a plurality of Persona Tests.

17. The method of claim 16, wherein said plurality of Persona Tests comprise a plurality of Persona-trait Tests and a plurality of Persona-category Tests.

18. The method of claim 17, wherein each one of said plurality of Persona-trait Tests comprises a stimulus comprising a person image, a trait and a trait question associating said trait and said person image; and wherein each one of said plurality of Persona-category Tests comprises a stimulus comprising a person image, a category and a category question associating said category with said person image.

19. The method of claim 18, further comprising analyzing answers of a plurality of second respondents to said plurality of traits questions and to said plurality of category questions, thereby determining said first, second and third weights corresponding to said person image.

20. The method of claim 19, wherein said selected stimuli are selected from said plurality of human visual stimuli according to a demographic profile of each second respondent who answered a question regarding said stimuli.

21. The method of claim 20, wherein said demographic profile comprises at least one of age, gender, residence, education level and socio-economic profile.

22. The method of claim 19, wherein said selected stimuli are selected from said plurality of human visual stimuli according to a reaction time of each second respondent who answered a question regarding said stimuli.

23. The method of claim 19, wherein the value of each of said first weights is equal to the proportion of second respondents who gave a positive answer to one of said trait questions related to said selected stimuli; and wherein the value of each of said second weights is equal to the proportion of second respondents who gave a positive answer to one of said category questions related to said selected stimuli.

24. (canceled)

25. (canceled)

26. (canceled)

27. (canceled)

28. (canceled)

29. (canceled)

30. (canceled)

31. (canceled)
